(19) United States
(12) Patent Application Publication
(10) Pub. No.: US 2024/0078653 A1
(43) Pub. Date: Mar. 7, 2024

(54) VISUAL INSPECTION METHOD OF A CURVED OBJECT

(71) Applicant: Cheng Uei Precision Industry Co., LTD., New Taipei City (TW)

(72) Inventors: SHUN-CHIEN LAN, New Taipei City (TW); WEI-CHENG TSENG, New Taipei City (TW); CHEN-YI LIU, New Taipei City (TW); CHEN-TE CHEN, New Taipei City (TW)

(21) Appl. No.: 18/212,644

(22) Filed: Jun. 21, 2023

(30) Foreign Application Priority Data
Sep. 6, 2022 (CN) 202211081944.7

(51) Int. Cl. G06T 7/00; G06T 1/00

(52) U.S. Cl. CPC G06T 7/0004; G06T 1/0014; G06T 2207/10004; G06T 2207/10144; G06T 2207/30168

(57) ABSTRACT

A visual inspection method of a curved object executed by a visual inspection system. The visual inspection system includes a robotic arm, a camera mounted at a tail end of the robotic arm, a fixing unit mounted under the camera, and a control unit electrically connected to the robotic arm and the camera. Specific steps of the visual inspection method of the curved object are described hereinafter. Fix a curved object which is to be inspected by the fixing unit. Capture the object which is to be inspected with a plurality of groups of preset parameters by the camera. Use the control unit to calculate a better shooting parameter. Use the better shooting parameter by the camera to proceed with visual inspections of the curved objects which are to be inspected in batches.

### CROSS-REFERENCE TO RELATED APPLICATION

The present application is based on, and claims priority from, China Patent Application No. 202211081944.7, filed Sep. 6, 2022, the disclosure of which is hereby incorporated by reference herein in its entirety.

### BACKGROUND OF THE INVENTION

### 1. Field of the Invention

The present invention generally relates to a visual inspection method of an object, and more particularly to a visual inspection method of a curved object which reduces re-adjusting times of photographing angles of the curved object.

### 2. The Related Art

Referring to FIG. 7, when an object 70 is in a visual inspection, and the object 70 has curved surfaces, different positions of the curved surfaces of the object 70 are spaced slightly different distances from a light source, normal vectors of the different positions of the curved surfaces of the object 70 are different, or materials used to the curved surfaces of the object 70 are different, exposure results are quite different even with the same exposure setting. As a result, the different surfaces of the object 70 may have extremely different exposure values frequently, and whether the surfaces of the object 70 have defects is unable to be clearly identified in one photograph.

For example, when the object 70 is placed under the light source and a camera 80, the light source illuminates the object 70, and the camera 80 shoots the object 70. The normal vector of the object 70 pointing towards the light source, a received light ray and a reflected light ray of a flat part of the object 70 are stronger, and a received light ray and a reflected light ray of an inclined part of the object 70 are weaker. Therefore, the flat part of the object 70 generally has the higher exposure value, and the inclined part of the object 70 is apt to be in an underexposure condition.

A conventional visual inspection system hardly identifies a structural detail of the object 70 on account of the underexposure and overexposure, so in order to clearly identify the different positions of the object 70, the conventional visual inspection system must adjust the positions and angles among the object 70 which is to be inspected, the light source and the camera 80 frequently to proceed with an individual shoot, so that each surface of the object 70 which is to be inspected is under the correct exposure.

However, that the positions and the angles among the camera 80, the light source, and the object 70 which is to be inspected is relatively time-consuming, so that visual inspection of the curved object 70 requires a lot of time for re-adjusting the shooting angle.

Thus, it is necessary to provide a visual inspection method of a curved object which reduces readjustments of photographing angles of the curved object.

### SUMMARY OF THE INVENTION

An object of the present invention is to provide a visual inspection method of a curved object executed by a visual inspection system. The visual inspection method of the curved object reduces re-adjusting times of photographing angles of the curved object. The visual inspection system includes a robotic arm, a camera mounted at a tail end of the robotic arm, a fixing unit mounted under the camera, and a control unit electrically connected to the robotic arm and the camera. When the visual inspection method of the curved object is performed by the control unit, specific steps of the visual inspection method of the curved object are described hereinafter. Fix a curved object which is to be inspected by the fixing unit. Capture the curved object which is to be inspected with a plurality of groups of preset parameters by the camera to obtain a plurality of groups of object images, and then the control unit counts a quantity of pixels occupied by each grayscale value in the object images. Use the control unit to calculate a better shooting parameter according to the quantity of the pixels occupied by the grayscale values in the object images, and the better shooting parameter is used for an inspection. Use the better shooting parameter for the inspection by the camera to proceed with visual inspections of the curved objects which are to be inspected in batches.

Another object of the present invention is to provide a visual inspection method of a curved object executed by a visual inspection system. The visual inspection system includes a robotic arm, a camera mounted at a tail end of the robotic arm, a fixing unit mounted under the camera, and a control unit electrically connected to the robotic arm and the camera. Specific steps of the visual inspection method of the curved object are described hereinafter. Fix a curved object which is to be inspected by the fixing unit. Capture the curved object which is to be inspected with a plurality of groups of preset parameters by the camera to obtain a plurality of groups of object images, and then the control unit counts a quantity of pixels occupied by each grayscale value in the object images. Use the control unit to calculate a better shooting parameter according to the quantity of the pixels occupied by the grayscale values in the object images, and the better shooting parameter is used for an inspection. Use the better shooting parameter for the inspection by the camera to proceed with visual inspections of the curved objects which are to be inspected in batches. When exposure time is shortened, the object images cause underexposure, and the overall grayscale values of the object images are reduced, relatively, direct accepting surface or light-colored region of the object images are avoided from an overexposure. When the exposure time is lengthened, the object images cause the overexposure and the overall grayscale values of the object images are increased, relatively, a backlight surface or a dark region of the object images are avoided from the underexposure.

Another object of the present invention is to provide a visual inspection method of a curved object executed by a visual inspection system. The visual inspection system includes a robotic arm, a camera mounted at a tail end of the robotic arm, a fixing unit mounted under the camera, and a control unit electrically connected to the robotic arm and the camera. Specific steps of the visual inspection method of the curved object are described hereinafter. Fix a curved object which is to be inspected by the fixing unit. Capture the curved object which is to be inspected with a plurality of groups of preset parameters by the camera to obtain a plurality of groups of object images, and then the control unit counts a quantity of pixels occupied by each grayscale value in the object images. Use the control unit to calculate a better shooting parameter according to the quantity of the pixels occupied by the grayscale values in the object images, and the better shooting parameter is used for an inspection, preset a target grayscale value by the control unit. Use the better shooting parameter for the inspection by the camera to proceed with visual inspections of the curved objects which are to be inspected in batches. The control unit adjusts photographing angles by controlling the robotic arm, and the control unit adjusts exposure parameters by controlling the camera, determine the better shooting parameter for the inspection by way of maximizing the quantity of the pixels occupied by the target greyscale values in the object images.

As described above, the control unit adjusts the photographing angles by controlling the robotic arm, and the control unit adjusts the exposure parameters by controlling the camera, the visual inspection method determines the shooting parameters for the inspection by way of maximizing the quantity of the pixels occupied by the target greyscale values in the object images, so that an object feature that is able to be observed at each photographing angle is maximized, and the visual inspection method of the curved object reduces re-adjusting times of the photographing angles of the curved object.

### BRIEF DESCRIPTION OF THE DRAWINGS

The present invention will be apparent to those skilled in the art by reading the following description, with reference to the attached drawings, in which:

FIG. 1 is a flowchart for a visual inspection of a curved object in accordance with a preferred embodiment of the present invention;

FIG. 2 is a flowchart for capturing obtained object images with preset parameters according to the preferred embodiment of the present invention;

FIG. 3 is a flowchart for calculating a shooting parameter according to a quantity of pixels occupied by grayscale values in the object images, wherein the shooting parameter is used for inspecting the curved object according to the preferred embodiment of the present invention;

FIG. 4 is a schematic diagram of capturing the object images with the different shooting parameters in accordance with the preferred embodiment of the present invention;

FIG. 5 is a schematic diagram of a visual inspection of the curved object in accordance with the preferred embodiment of the present invention;

FIG. 6 is a partial block diagram of a visual inspection system in accordance with the preferred embodiment of the present invention; and

FIG. 7 is a schematic diagram of a visual inspection of an object in prior art.

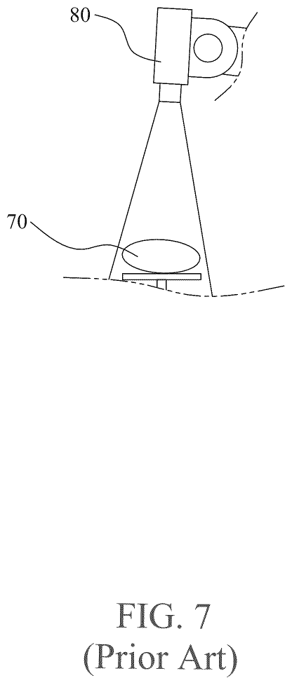

### DETAILED DESCRIPTION OF THE PREFERRED EMBODIMENT

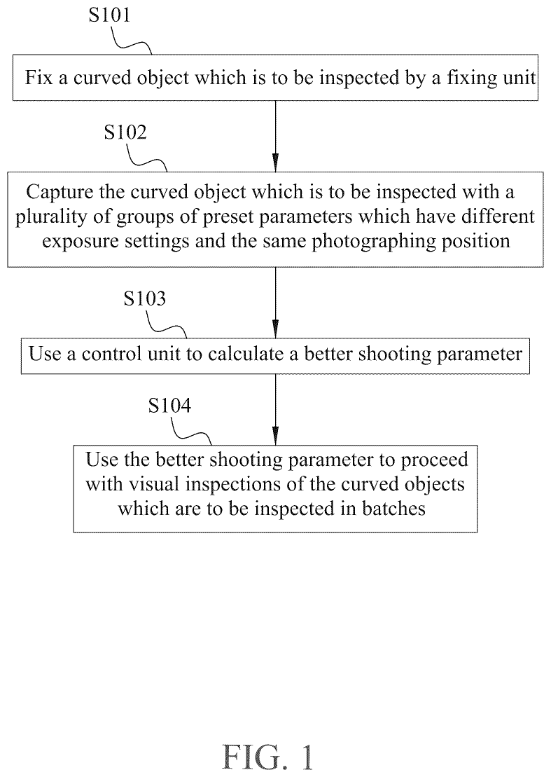

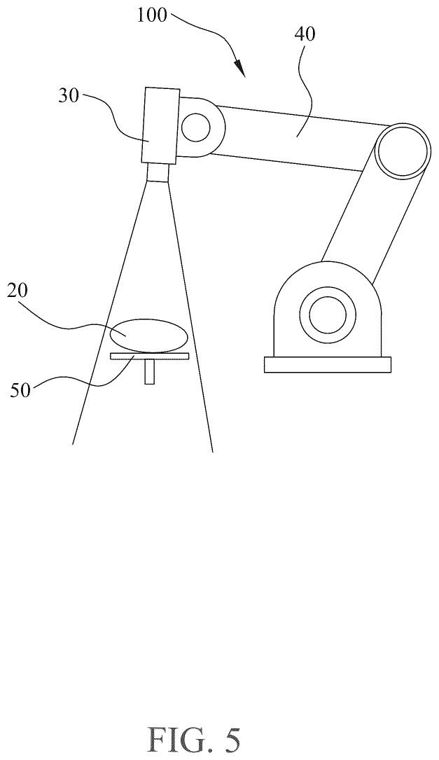

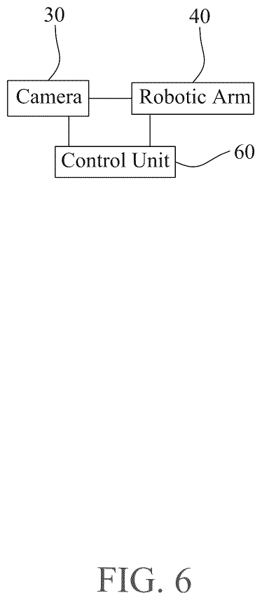

Referring to FIG. 1 to FIG. 6, a visual inspection method of a curved object 20 in accordance with a preferred embodiment of the present invention is shown. The visual inspection method of the curved object 20 according to the present invention is able to be performed in different visual inspection devices. In this preferred embodiment, the visual inspection method of the curved object 20 is performed by a visual inspection system 100. The visual inspection system 100 includes a robotic arm 40, a camera 30 which is mounted at a tail end of the robotic arm 40, a fixing unit 50, and a control unit 60. The fixing unit 50 is mounted under the camera 30 for fastening the curved object 20 which is to be inspected. The control unit 60 is electrically connected to the robotic arm 40 and the camera 30 for adjusting photographing angles by controlling the robotic arm 40 and exposure parameters by controlling the camera 30.

In this preferred embodiment, when the visual inspection method of the curved object 20 is performed by the control unit 60, specific steps of the visual inspection method of the curved object 20 are described as follows.
S101: fix the curved object 20 which is to be inspected by the fixing unit 50.
S102: capture the curved object 20 which is to be inspected with a plurality of groups of preset parameters which have different exposure settings and the same photographing position by the camera 30 to obtain a plurality of groups of object images 10, and then the control unit 60 counts a quantity of pixels occupied by each grayscale value in the object images 10.
S103: use the control unit 60 to calculate a better shooting parameter according to the quantity of the pixels occupied by the grayscale values in the object images 10, and the better shooting parameter is used for an inspection.
S104: perform the visual inspections of a plurality of the curved objects 20 which are to be inspected with shooting parameters for the inspection which is calculated in the previous step S103. The shooting parameters for the inspection include the better shooting parameter for the inspection. Specifically, use the better shooting parameter for the inspection by the camera 30 to proceed with the visual inspections of the curved objects 20 which are to be inspected in batches.

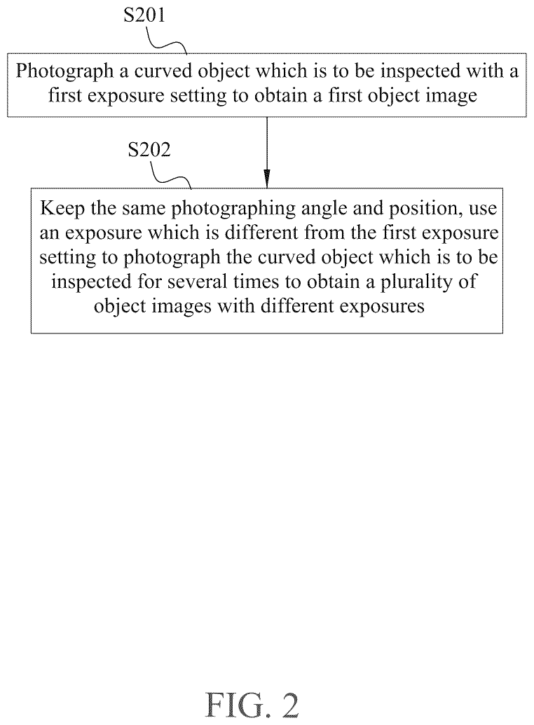

Referring to FIG. 1 and FIG. 2, the step S102 of capturing the object 20 which is to be inspected with the plurality of the groups of the preset parameters further includes following steps.
S201: photograph the curved object 20 which is to be inspected with a first exposure setting to obtain a first object image 11, and the control unit 60 counts the quantity of the pixels occupied by each grayscale value in the first object image 11.
S202: keep the same photographing angle and position by the camera 30, use an exposure which is different from the first exposure setting to photograph the curved object 20 which is to be inspected for several times to obtain the plurality of the object images 10 with different exposures, and the control unit 60 counts the quantity of the pixels occupied by each grayscale value in the object images 10 with the different exposures.

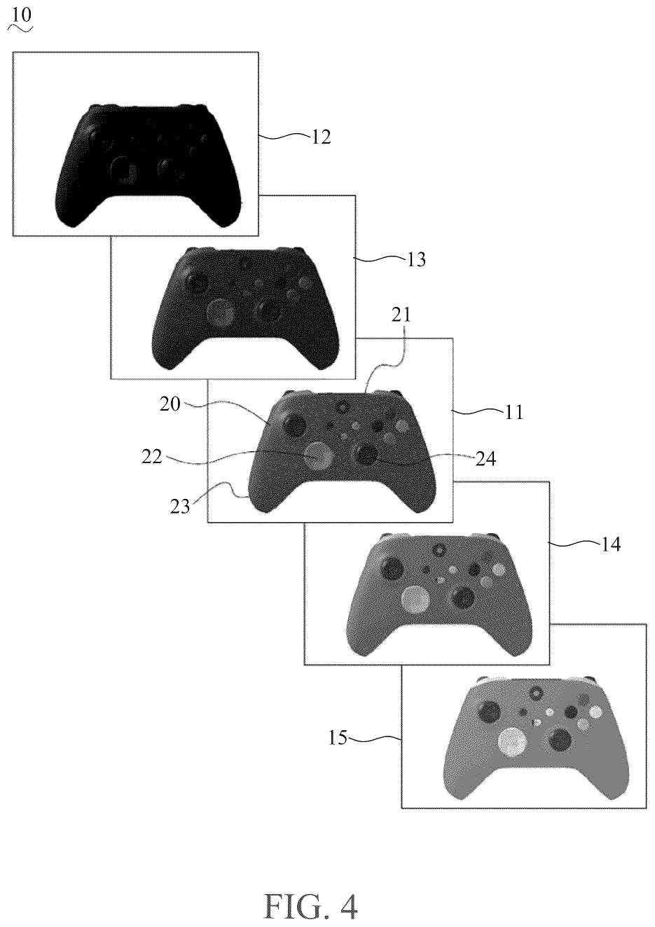

Referring to FIG. 2 and FIG. 4, in this preferred embodiment, the first object image 11 is captured with an exposure time of 300 ms in the step S201. In the step S202 of using the exposure which is different from the first exposure setting to photograph the object 20 which is to be inspected for several times, use the same photographing angle, position, light source, aperture and sensitivity to photograph the object 20 which is to be inspected with an exposure time of 100 ms, an exposure time of 200 ms, an exposure time of 400 ms and an exposure time of 500 ms to obtain a second object image 12, a third object image 13, a fourth object image 14 and a fifth object image 15, then count the quantity of the pixels occupied by each grayscale value which is in the first object image 11, the second object image 12, the third object image 13, the fourth object image 14 and the fifth object image 15. Use the exposure which is lower than the first exposure setting by the camera 30 to photograph the object 20 which is to be inspected to obtain a lower exposure object image, then the control unit 60 counts the quantity of the pixels occupied by each grayscale value which is in the lower exposure object image. Use the exposure which is higher than the first exposure setting by the camera 30 to photograph the object 20 which is to be inspected to obtain a higher exposure object image, then the control unit 60 counts the quantity of the pixels occupied by each grayscale value which is in the higher exposure object image.

When the exposure time is shortened, the object images 10 cause underexposure, and the overall grayscale values of the object images 10 are reduced. Relatively, direct accepting surface or light-colored region of the object images 10 are also avoided from the overexposure. On the contrary, when the exposure time is lengthened, the object images 10 cause the overexposure and the overall grayscale values of the object images 10 are increased, relatively, a backlight surface or a dark region of the object images 10 are avoided from the underexposure. The overall gray-scale values of the second object image 12 and the third object image 13 which have shorter exposure time are lower. Simultaneously, a turning position 21 at a top of a handgrip and a cross key 22 of the handgrip are avoided from the overexposure. The overall gray-scale values of the fourth object image 14 and the fifth object image 15 which take longer exposure time are higher, and an underexposure of a surface 23 of the controller and a rocker cap 24 of the controller are avoided.

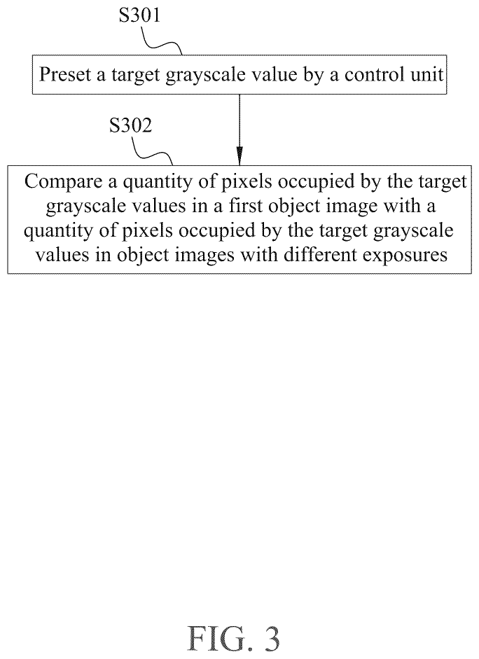

Referring to FIG. 1, FIG. 3 and FIG. 4, after the first object image 11 and the fifth object image 15 are obtained with the different shooting parameters, following steps are further executed. The step S103 of using the control unit 60 to calculate the better shooting parameter includes the following steps.
S301: preset a target grayscale value by the control unit 60, the target grayscale value in this preferred embodiment is set to a middle value of a range of the grayscale values in the object images 10 to avoid that the target grayscale value falls into an underexposure range or an overexposure range during sampling, a selection of this target greyscale value still need be adjusted depending on a material or a color of the curved object 20 which is to be inspected.
S302: compare the quantity of the pixels occupied by the target grayscale values in the first object image 11 with the quantity of the pixels occupied by the target grayscale values in the object images with the different exposures, and set an exposure setting of the object image that has a larger quantity of the pixels occupied by the target grayscale values as the better shooting parameters for the inspection. Specifically, compare the quantity of the pixels occupied by the target grayscale values in the first object image 11 with the quantity of the pixels occupied by the target grayscale values in the fifth object image 15, and set the exposure setting of the object image that has the larger quantity of the pixels occupied by the target grayscale values as the shooting parameters for the inspection.

In order to enlarge an area coverage of the object images which is available for the visual inspection, a way of randomly selecting two object images 10 from the first object image 11 to the fifth object image 15 as an object image group is adopted, count the quantities of the pixels which fall into the target grayscale values and in different object image groups, and compare the quantities of the pixels which fall into the target grayscale values and in the different object image groups. After counting and comparing the quantities of the pixels which fall into the target grayscale values and in the different object image groups, the counted and compared results reveal that the object image groups which are combined with the third object image 13 and the fourth object image 14 are able to maximize the quantity of the pixels of the target grayscale values, so that in the step S103, two sets of the shooting parameters of the third object image 13 and the fourth object image 14 are combined as the shooting parameters for the inspection.

In the step S104, use the shooting parameters for the inspection to inspect the subsequent curved objects 20 which are to be inspected in batches, and the shooting parameters for the inspection are obtained in the previous step S103. Successively, each curved object 20 which is to be inspected use exposure time of 200 ms and 400 ms respectively to photograph the object images 10, and then the photographed object images 10 proceed with the visual inspection.

As described above, the control unit 60 adjusts the photographing angles by controlling the robotic arm 40, and the control unit 60 adjusts the exposure parameters by controlling the camera 30, the visual inspection method in the present invention determines the shooting parameters for the inspection by way of maximizing the quantity of the pixels occupied by the target greyscale values in the object images, so that an object feature that is able to be observed at each photographing angle is maximized, and the visual inspection method of the curved object 20 reduces re-adjusting times of the photographing angles of the curved object 20.

Although the foregoing preferred embodiment of the present invention is disclosed above, nevertheless, the preferred embodiment is without being intended to limit the present invention. Any person skilled in the like art may make minor alterations and embellishments without departing from a spirit and a scope of the present invention, and a patent protection scope of the present invention shall be accurately defined depending on an application patent scope attached to this specification.

What is claimed is:

1. A visual inspection method of a curved object executed by a visual inspection system, the visual inspection system including a robotic arm, a camera mounted at a tail end of the robotic arm, a fixing unit mounted under the camera, and a control unit electrically connected to the robotic arm and the camera, when the visual inspection method of the curved object is performed by the control unit, the visual inspection method of the curved object comprising steps of:
fixing a curved object which is to be inspected by the fixing unit;
capturing the curved object which is to be inspected with a plurality of groups of preset parameters by the camera to obtain a plurality of groups of object images, and then the control unit counting a quantity of pixels occupied by each grayscale value in the object images;
using the control unit to calculate a better shooting parameter according to the quantity of the pixels occupied by the grayscale values in the object images, and the better shooting parameter being used for an inspection; and
using the better shooting parameter for the inspection by the camera to proceed with visual inspections of the curved objects which are to be inspected in batches.

2. The visual inspection method of the curved object as claimed in claim 1, wherein the step of capturing the curved object which is to be inspected with the plurality of the groups of the preset parameters further includes following steps: photograph the curved object which is to be inspected with a first exposure setting to obtain a first object image, and the control unit counts the quantity of the pixels occupied by each grayscale value in the first object image, keep the same photographing angle and position by the camera, use an exposure which is different from the first exposure setting to photograph the object which is to be inspected for several times to obtain the plurality of the object images with different exposures, and the control unit counts the quantity of the pixels occupied by each grayscale value in the object images with the different exposures.

3. The visual inspection method of the curved object as claimed in claim 2, wherein in the step of using the exposure which is different from the first exposure setting to photograph the object which is to be inspected for several times, use the exposure which is lower than the first exposure setting by the camera to photograph the object which is to be inspected to obtain a lower exposure object image, then the control unit counts the quantity of the pixels occupied by each grayscale value which is in the lower exposure object image, use the exposure which is higher than the first exposure setting by the camera to photograph the object which is to be inspected to obtain a higher exposure object image, then the control unit counts the quantity of the pixels occupied by each grayscale value which is in the higher exposure object image.

4. The visual inspection method of the curved object as claimed in claim 2, wherein the step of using the control unit to calculate the better shooting parameter includes following steps, preset a target grayscale value by the control unit, compare the quantity of the pixels occupied by the target grayscale values in the first object image with the quantity of the pixels occupied by the target grayscale values in the object images with the different exposures, and set an exposure setting of the object image that has a larger quantity of the pixels occupied by the target grayscale values as the better shooting parameters for the inspection.

5. A visual inspection method of a curved object executed by a visual inspection system, the visual inspection system including a robotic arm, a camera mounted at a tail end of the robotic arm, a fixing unit mounted under the camera, and a control unit electrically connected to the robotic arm and the camera, the visual inspection method of the curved object comprising steps of:
fixing a curved object which is to be inspected by the fixing unit;
capturing the curved object which is to be inspected with a plurality of groups of preset parameters by the camera to obtain a plurality of groups of object images, and then the control unit counting a quantity of pixels occupied by each grayscale value in the object images;
using the control unit to calculate a better shooting parameter according to the quantity of the pixels occupied by the grayscale values in the object images, and the better shooting parameter being used for an inspection; and
using the better shooting parameter for the inspection by the camera to proceed with visual inspections of the curved objects which are to be inspected in batches;
wherein when exposure time is shortened, the object images cause underexposure, and the overall grayscale values of the object images are reduced, relatively, direct accepting surface or light-colored region of the object images are avoided from an overexposure; and
wherein when the exposure time is lengthened, the object images cause the overexposure and the overall grayscale values of the object images are increased, relatively, a backlight surface or a dark region of the object images are avoided from the underexposure.

6. A visual inspection method of a curved object executed by a visual inspection system, the visual inspection system including a robotic arm, a camera mounted at a tail end of the robotic arm, a fixing unit mounted under the camera, and a control unit electrically connected to the robotic arm and the camera, the visual inspection method of the curved object comprising steps of:
fixing a curved object which is to be inspected by the fixing unit;
capturing the curved object which is to be inspected with a plurality of groups of preset parameters by the camera to obtain a plurality of groups of object images, and then the control unit counting a quantity of pixels occupied by each grayscale value in the object images;
using the control unit to calculate a better shooting parameter according to the quantity of the pixels occupied by the grayscale values in the object images, and the better shooting parameter being used for an inspection, presetting a target grayscale value by the control unit; and
using the better shooting parameter for the inspection by the camera to proceed with visual inspections of the curved objects which are to be inspected in batches;
wherein the control unit adjusts photographing angles by controlling the robotic arm, and the control unit adjusts exposure parameters by controlling the camera, determine the better shooting parameter for the inspection by way of maximizing the quantity of the pixels occupied by the target greyscale values in the object images.
